(19) United States
(12) Patent Application Publication
(10) Pub. No.: US 2018/0054227 A1
(43) Pub. Date: Feb. 22, 2018

(54) Cell-Matte

(71) Applicant: David Wolf, Kissimmee, FL (US)

(72) Inventor: David Wolf, Kissimmee, FL (US)

(21) Appl. No.: 15/242,584

(22) Filed: Aug. 21, 2016

(51) Int. Cl. H04B 1/3888; B32B 5/18; B32B 25/16; B32B 25/04

(52) U.S. Cl. CPC H04B 1/3888; B32B 5/18; B32B 25/16; B32B 2571/00; B32B 2307/744; B32B 2457/00; B32B 25/045

(57) ABSTRACT

A memory foam, neoprene coated non-slip article used in the classroom to protect students' personal communication devices.

### CROSS REFERENCE TO APPLICATIONS

None Found

### STATEMENT OF FEDERALLY SPONSORED RESEARCH OR DEVELOPMENT

NA

### THE NAMES OF THE PARTIES TO A JOINT RESEARCH AGREEMENT

NA

### REFERENCE TO A “SEQUENCE LISTING,” A TABLE, OR A COMPUTER PROGRAM LISTING

NA

### BACKGROUND OF THE INVENTION

Texting in class is the biggest distraction to the instruction and learning process. Students keep the phones in their hands, laps under the desk, or even text in a back pack that leads to the interruption of instruction. The Cell-Matte is a classroom management tool that keeps the student's phones in view and provides a designated spot that protects the phone from sliding and protects the screen from the hard surface of the desk. The backside has double stick tape that easily secures the item to the desk. When the device is on the pad face down, it is in the “no use” zone. When the devices are allowed for academic purposes, the students have a safe place to set down the phone.

### BRIEF SUMMARY OF THE INVENTION

The Cell-Matte attaches to a school desktop. The product is designed with grip material to protect the phone from sliding and to protect the phone's screen from the hard surface.

### BRIEF DESCRIPTION OF THE SEVERAL VIEWS OF THE DRAWING

FIG. 1—A top view of the mat showing the length and width.

FIG. 2—A top view of the mat with silk screening.

FIG. 3—A straight on top view.

FIG. 4—A view of the phone face down on the protective mat.

FIG. 5—A straight on view of the mat with silk screening.

FIG. 6—A side view of a phone on the mat.

FIG. 7—Showing the non-skid grip of the phone on the mat.

FIG. 8—A view of the backside of the mat with three strips of double stick tape.

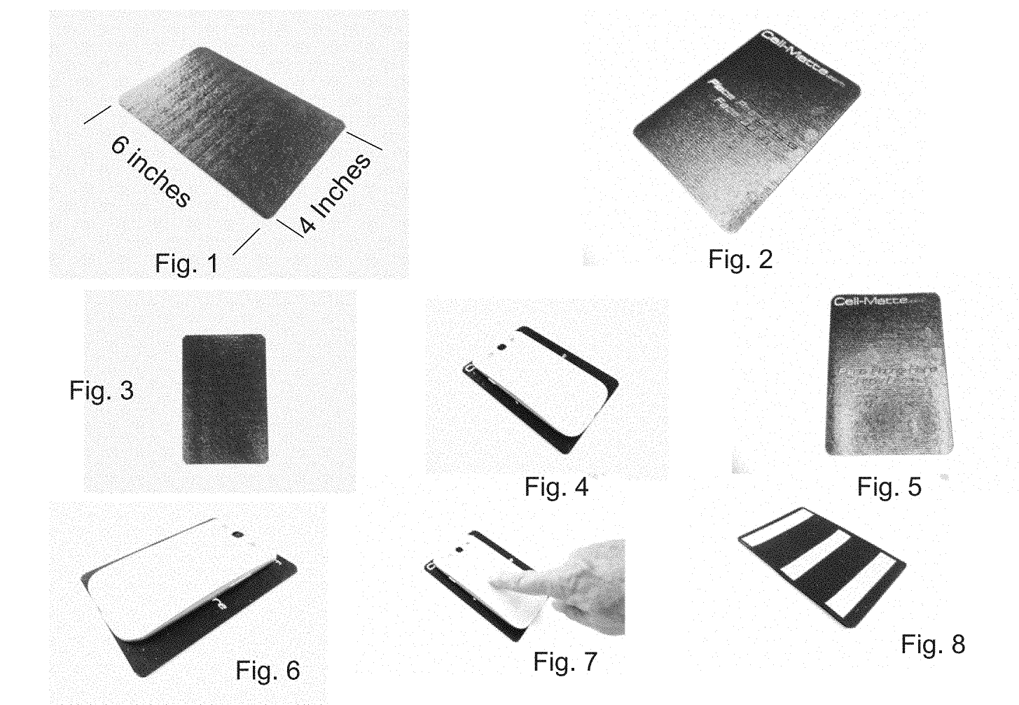

### DETAILED DESCRIPTION OF THE INVENTION

Cell-Matte is a mat made with high quality memory foam with high quality neoprene upper and lower surfaces that are non-skid and has self adhesive backing to attach to the desk top surface. Its dimensions are 4 inches wide, 6 inches tall, and 1/16th of an inch thick to accommodate a wide selection of personal communication devices.

1. A personal communication protection device: A black or colored memory foam mat with upper and lower layer of high quality neoprene for a non-skid surface to protect the communication device.

2. Invented for use in the classroom to detour distractions during instruction by providing a place to keep the phone on the desk.

3. Phone and screen are protected.

4. Cell-Matte has a self adhesive backing for attaching to the desk surface.

5. When attached to the desk surface, student's phones are placed on top of the Cell-Matte and will not slide or move.
